(19) United States
(12) Patent Application Publication
(10) Pub. No.: US 2024/0400802 A1
(43) Pub. Date: Dec. 5, 2024

(54) POROUS MEMBRANE AND POLYMER COMPOSITIONS FOR MAKING SAME

(71) Applicant: Celanese International Corporation, Irving, TX (US)

(72) Inventors: Nagarjuna Palyam, Florence, KY (US); Soyeon Park, Seoul (KR); Dirk Hair, Edmonton (CA); David Ditter, Russelsheim (DE)

(21) Appl. No.: 18/652,850

(22) Filed: May 2, 2024

Related U.S. Application Data
(60) Provisional application No. 63/568,680, filed on Mar. 22, 2024.
(60) Provisional application No. 63/504,876, filed on May 30, 2023.

(51) Int. Cl. C08L 23/06; C08J 9/28; H01M 50/417

(52) U.S. Cl. CPC C08L 23/06; C08J 9/28; H01M 50/417; C08J 2323/06; C08J 2431/04

(57) ABSTRACT

A polymer composition for producing gel extruded articles is described. The polymer composition contains one or more high density polyethylene polymers combined with one or more olefinic copolymers. In order to form gel extruded articles, the polymer composition is combined with a plasticizer. In one embodiment, the polymer composition is used to form a porous membrane for use as a separator in electronic devices. The presence of the olefinic copolymer can increase the adhesive characteristics of membranes made from the composition when placed in contact with an anode and/or a cathode. When producing porous membranes, the olefin copolymer can also decrease the shutdown temperature and increase wettability properties.

This application claims filing benefit of U.S. Provisional Patent Application Ser. No. 63/504,876 having a filing date of May 30, 2023, and U.S. Provisional Patent Application Ser. No. 63/568,680 having a filing date of Mar. 22, 2024, which is incorporated herein by reference for all purposes.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane and may be stretched in one or two directions. After the article is formed, all of the solvent may be removed from the product.

Membranes made from polyethylene polymers through gel-processing can be formed to have many beneficial properties. For instance, the membranes can be formed with micro-pores. Microporous polyethylene membranes formed through gel-processing, for instance, are particularly well suited for use as a separator in a battery, such as a lithium ion battery. The microporous membrane, for instance, can separate an anode from a cathode and prevent a short circuit between the active battery components. At the same time, the microporous membrane permits ions to pass through due to the porous nature of the material. The ion permeability characteristics of the microporous polyethylene membrane makes the material particularly well suited for regulating electrochemical reactions within the battery.

In view of the above, one of the important characteristics of lithium ion battery membranes is the compatibility between the membrane and the other components contained within the electrochemical cell, such as the anode, the cathode, and the electrolyte solution.

Another important characteristic of polyethylene membranes is their ability to have a relatively low shutdown temperature, which is referred to as having an effective “shutdown effect”. The shutdown effect refers to the self-closing of micro-pores within the polyethylene separator when it surpasses a certain temperature. When the pores in the polyethylene membrane are closed upon reaching a certain temperature, ions can no longer pass through the membrane and the electrochemical function of the battery stops. This effect becomes an important safety feature for the battery as it prevents thermal runaway reactions from continuing and prevents the battery from overheating and creating a potentially hazardous situation.

In addition to a shutdown temperature, polyethylene membranes also have a meltdown temperature, which refers to the temperature at which the membrane loses its mechanical stability and rupture occurs. Ideally, the polymer membrane has a relatively low shutdown temperature while possessing a relatively high meltdown temperature in order to provide electrical devices, such as batteries, with safety and stability.

The present disclosure is generally directed to further improvements in high density polyethylene articles formed through gel extrusion. In one aspect, the present disclosure is directed to producing a porous membrane that may be used in electrochemical cells that has an improved affinity or improved adhesive properties when placed in contact with an anode or a cathode. Porous membranes made according to the present disclosure can also have improved wettability characteristics. The above improvements can be realized without adversely impacting other properties of the porous membrane. In fact, in one aspect, porous membranes can be made that display lower shutdown temperatures.

### SUMMARY

In general, the present disclosure is directed to polyolefin compositions well suited for gel-processing applications. More particularly, the present disclosure is directed to a polymer composition containing at least one high density polyethylene polymer well suited for producing microporous, ion permeable membranes that may be used as separators in batteries. The polymer composition can contain a single high density polyethylene polymer or a blend of high density polyethylene polymers. In accordance with the present disclosure, the polymer composition is formulated so as to have at least one improved characteristic or property. For instance, porous membranes made according to the present disclosure can display an increased adhesive bond to an adjacent structure, such as an anode or a cathode, in an electrochemical cell. In addition, the porous membrane can also display improved wettability characteristics, particularly with respect to the electrolyte solution found in lithium ion batteries. The improved wettability characteristics increase the mobility of ions contained within the lithium ion battery which increases battery efficiency and lifetime. In still another aspect, porous membranes can be made according to the present disclosure that display an improved shutdown temperature.

In one embodiment, for instance, the present disclosure is directed to a porous membrane made from at least one high density polyethylene polymer blended with an olefinic copolymer. The polyethylene polymer can have a number average molecular weight of greater than about 300,000 g/mol. The olefinic copolymer, on the other hand, can comprise an ethylene vinyl acetate copolymer. The ethylene vinyl acetate copolymer can have a controlled amount of vinyl acetate monomer units. For instance, the ethylene vinyl acetate copolymer can have a vinyl acetate monomer content of less than about 30% by weight, such as less than about 29% by weight, such as less than about 25% by weight, such as less than about 20% by weight, such as less than about 15% by weight. The ethylene vinyl acetate can have a vinyl acetate monomer content of from about 5% to about 29% by weight, such as from about 5% to about 15% by weight, such as from about 5% to about 12% by weight.

The ethylene vinyl acetate copolymer can be present in the porous membrane in an amount from about 0.1% by weight to about 30% by weight, such as in an amount from about 0.1% by weight to about 20% by weight, such as in an amount from about 0.3% by weight to about 12% by weight. The ethylene vinyl acetate copolymer, in one embodiment, can have a melt flow index of from about 0.1 g/10 min to about 20 g/10 min, such as from about 0.1 g/10 min to about 5 g/10 min as determined in accordance with ASTM Test D1238-20 at a temperature of 190° C. and at a load of 2.16 kilograms.

In one aspect, the olefinic copolymer can be present in the porous film in an amount sufficient to reduce the shutdown temperature of the membrane or film. For instance, the porous membrane can have a shutdown temperature of from about 120° C. to less than about 140° C., such as from about 120° C. to about 138° C., such as from about 120° C. to about 135° C., such as from about 120° C. to about 133° C. The olefinic copolymer, for instance, can be present in the porous membrane in an amount sufficient to reduce the shutdown temperature by at least about 1.8° C., such as at least about 2.2° C., such as at least about 2.5° C., such as at least about 3° C., such as at least about 3.5° C. in comparison to an identical porous membrane not containing the olefinic copolymer.

The porous membrane of the present disclosure can have enhanced wicking properties when tested against electrolyte solutions, such as propylene carbonate. For example, the olefinic copolymer can be present in the porous membrane sufficient to increase a wicking distance of the membrane when measured according to a soaking test using propylene carbonate. The wicking distance can be increased in an amount of greater than about 10%, such as in an amount greater than about 20%, such as in an amount greater than about 30%, such as in an amount greater than about 35% in comparison to a porous membrane not containing the olefinic copolymer.

In another aspect, the olefinic copolymer can also have an effect on the wettability characteristics of the porous membrane. For instance, the olefinic copolymer can optionally be present in the porous membrane in an amount sufficient to reduce a contact angle of the membrane when measured against water. For example, the contact angle of the membrane can be decreased by more than about 4%, such as more than about 5%, such as more than about 6%, such as more than about 7% in comparison to a contact angle of a similar membrane not containing the olefinic copolymer. For example, the contact angle of the porous membrane against water can be less than about 105°, such as less than about 102°, such as less than about 100°, such as less than about 98°.

The molecular weight of the at least one high density polyethylene polymer can be greater than about 500,000 g/mol, such as greater than about 650,000 g/mol, such as greater than about 800,000 g/mol, such as greater than about 1,000,000 g/mol, such as greater than about 2,000,000 g/mol, and generally less than about 12,000,000 g/mol, such as less than about 10,000,000 g/mol. As used herein, the molecular weight is determined according to the Margolies equation.

Porous membranes made according to the present disclosure can be single layer membranes that are free of polypropylene polymers. If desired, the membranes can be optionally coated with an inorganic coating or a polymer coating. In general, the porous membrane can have a thickness of from about 4 microns to about 25 microns. The porous membrane can have a Gurley permeability of generally greater than about 50 sec/100 mL, such as greater than about 70 sec/100 mL. The porosity of the membrane can be from about 20% to about 60%, such as from about 25% to about 50%.

Porous membranes made according to the present disclosure can be characterized by an IR spectrum having peaks at 1740, 1240, and 1020 cm−1±20 cm−1, such as ±5 cm−1.

The present disclosure is also directed to a polymer composition for producing gel extruded articles. The polymer composition comprises a plasticizer, high density polyethylene particles and an olefinic copolymer, such as an ethylene vinyl acetate copolymer.

The high density polyethylene particles used to produce the membrane can, in one embodiment, have a median particle size (d50) by volume of less than about 500 microns, such as less than about 150 microns, and generally greater than about 50 microns. In one embodiment, the olefinic copolymer can have a median particle size that is within about 20%, such as within about 10% of the median particle size of the high density polyethylene particles. The olefinic copolymer particles, for instance, can have a median particle size of from about 70 microns to about 1000 microns, such as from about 70 microns to about 700 microns, such as from about 70 microns to about 600 microns, such as from about 70 microns to about 200 microns.

The ethylene vinyl acetate copolymer can have a vinyl acetate monomer content of less than about 30%, such as from about 5% to about 29% by weight. The ethylene vinyl acetate copolymer can have a melt flow index of from about 0.1 g/10 min to about 20 g/10 min. The ethylene vinyl acetate copolymer can be present in the polymer composition in an amount from about 0.1% to about 20% by weight.

Various different materials can be used as the plasticizer. For instance, the plasticizer may comprise a mineral oil, a paraffinic oil, a hydrocarbon oil, an alcohol, or the like. For instance, the plasticizer may comprise decaline, xylene, dioctyl phthalate, dibutyl phthalate, stearyl alcohol, oleyl alcohol, decyl alcohol, nonyl alcohol, diphenyl ether, n-decane, n-dodecane, or mixtures thereof. In one embodiment, the plasticizer may comprise a C5-C12 hydrocarbon, such as a C5-C12 saturated hydrocarbon. For example, the plasticizer may comprise heptane, hexane, a paraffin, or the like.

The present disclosure is also directed to polymer articles formed from the above polymer composition. The polymer articles can be produced through a gel extrusion or gel-spinning process. Polymer articles made in accordance with the present disclosure include fibers, films, such as membranes, or the like.

During the formation of polymer articles, a significant portion of the plasticizer is removed. For example, in one aspect, greater than 95% by weight, such as greater than about 98% by weight of the plasticizer is removed in forming the polymer article. Consequently, polymer articles made in accordance with the present disclosure generally contain the high density polyethylene polymer in an amount of from about 60% to about 99% by weight, such as in an amount from about 80% to about 98% by weight. The polymer articles can contain the olefinic copolymer generally in an amount from about 0.1% by weight to about 30% by weight, such as from about 1% by weight to about 12% by weight.

The present disclosure is also directed to a process for producing polymer articles. The process includes the steps of forming a gel-like composition from the polymer composition described above. The gel-like composition is then extruded through a die to form a polymer article. The polymer article, for instance, may comprise a porous membrane.

In one embodiment, an extraction solvent, such as dichloromethane is combined with the polymer composition before or during formation of the polymer article. The extraction solvent can be used to facilitate removal of the plasticizer.

Other features and aspects of the present disclosure are discussed in greater detail below.

### BRIEF DESCRIPTION OF THE DRAWINGS

The present disclosure may be better understood with reference to the following figures:

FIG. 1 is a cross-sectional view of an electronic device, such as a battery, incorporating a porous membrane made in accordance with the present disclosure; and

FIG. 2 is a plot or graph illustrating the shutdown temperature and the meltdown temperature of a porous membrane using an Impedance Test.

FIG. 3 is a graph of data from the examples below;

FIG. 4 displays IR spectroscopy data from a composition made in accordance with the present disclosure; and

FIG. 5 is one embodiment of a process for subjecting a membrane made in accordance with the present disclosure to a plasma source.

Repeat use of reference characters in the present specification and drawings is intended to represent the same or analogous features or elements of the present invention.

### DEFINITIONS

The melt flow rate of a high density polyethylene polymer or polymer composition is measured according to ISO Test 1133 at 190° C. and at a load of 21.6 kg.

The density of a polymer is measured according to ISO Test 1183 in units of g/cm³.

Median particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in sec/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen&Wettre Micrometer,code 251(0.1 um); and Deli 2056 art knife.

### Procedure

### 1.1. Samples and Sample Preparation

Using the specimen art knife, cut each sample material into a minimum of three 60 mm±0.5 by 60 mm±0.5 specimens

### 1.2. Instrument and Measurement

3.2.1 Using the L&W micrometer, take five readings of the thickness at each 60 mm by 60 mm specimen (average of 5 readings). Record this value as the thickness of this specimen.
3.2.2 Weigh the specimen directly on the balance. Record this value as the weight of this specimen.
3.2.3 The three specimens of the same sample are placed together and steps
3.2.1 and 3.2.2 are repeated to obtain the [bulk] thickness and the [bulk] weight.
Calculate the density to three significant figures as follows

$$\begin{matrix}a . & \\ Dfilm = Density ( film ) = \frac{Wt . of Specimen}{THK * Square} & \end{matrix}$$

Dfilm=density of specimen, (mg/mm3)
Wt=weight of specimen, (mg)
THK=thickness of specimen, (mm)
Square=area of specimen, (mm2)
   b. Dpolymer=Density(polymer) 0.95 (g/cm3)
Dpolymer: Density of raw materials, without the pores.

$$\begin{matrix}c . & \\ Porosity = ( 1 - Dfilm / Dpolymer ) * 100 \% & \end{matrix}$$

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in×3 in) in an oven at 105° C. for 1 h. Shrinkage is calculated by measuring the size in MD and TD direction before and after heat treatment.

The shutdown temperature of a porous polymer membrane is the temperature at which the pores of the membrane close and no longer allow ions to pass through. For example, when tested according to the Impedance Test, it is the temperature at which the impedance initially increases to over 800 Ohms. It is also the temperature at which the polymer membrane starts to melt and pores close.

The meltdown temperature of a porous membrane is the temperature at which the membrane loses its mechanical stability and rupture occurs. Under the thermomechanical analysis test (TMA test), the dimension change of the membrane is measured while the sample is subjected to a temperature regime and a static force of 0.01 N is applied. The test is performed over a temperature range from 40° C. to 200° C. with a heating rate of 5° C./min. Data evaluation is done with a plot of dimension change versus temperature and the melt down temperature is indicated when dimension change increases and exceeds 1000 microns. The test can be conducted on a TA Instruments Thermo mechanical Analyzer (TMA) model Q400, Film/Fiber probe, MCA cooling system.

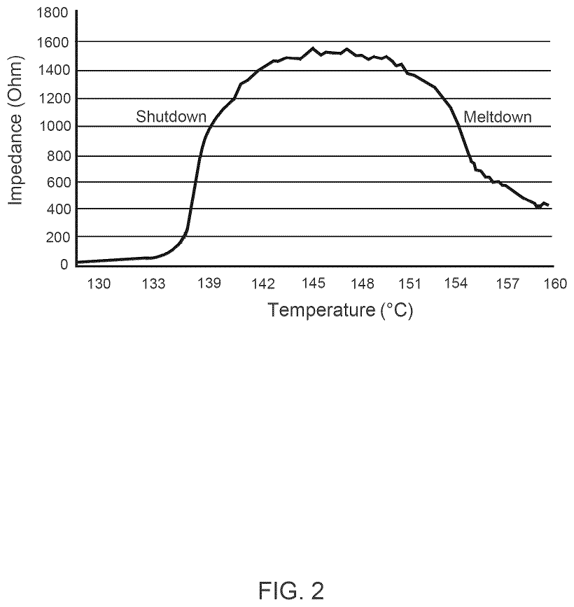

The shutdown temperature and meltdown temperature of a porous polymer membrane are illustrated, for instance, in FIG. 2.

The shutdown temperature or meltdown temperature of a polymer article, such as a microporous membrane, can vary depending upon the type of test and instrument used to measure the shutdown temperature. In fact, the shutdown temperature can vary widely depending upon the procedure, molecular weight of the base resin, and equipment used to make the determination. Thus, any reported shutdown temperatures for various products can be much lower than if a different test or technique is used.

In the present disclosure, the shutdown temperature of a polymer article, such as a porous membrane or of a polymer composition can be determined according to the “Impedance Test,” the “Thermomechanical Analysis Test,” and the “Differential Scanning Calorimetry Test. The Impedance Test, however, is the only test that directly measures shutdown temperature. The following tests are defined as follows.

### Impedance Test

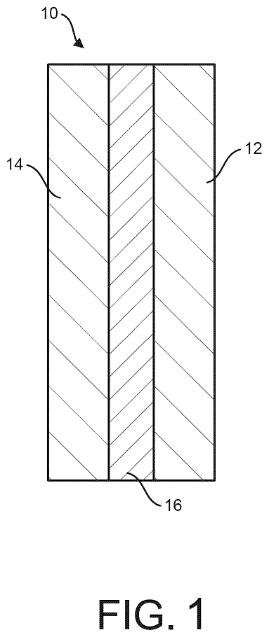

The impedance spectroscopy test setup consists of a glass measurement cell containing two steel electrodes. According to the impedance spectroscopy method, the sample is soaked in an electrolyte (1M LiPF₆ in 1:1 ethylene carbonate/dimethyl carbonate) and assembled into the cell between the electrodes. The measurement cell is then connected to an impedance spectrometer that records impedance spectrum every 50 seconds at a frequency between 100 Hz and 100 kHz. The measurement cell is then placed in an oven and heated over 2 hours from 110° C. to 150° C. while continuously recording impedance spectra. Data evaluation is done with a plot of impedance versus temperature and shutdown temperature is indicated by midway of a steep increase in impedance. An example plot is demonstrated in FIG. 1 in which the arrows indicate shutdown temperature. The test can be conducted using an HCP-803 potentiostat available from Biologic Science Instruments.

### Thermo Mechanical Analysis (TMA Test)

Under the TMA method, the dynamic strain is measured while the sample is subjected to a temperature regime and a static force of 0.2 N with a force multiplier of 0.5. The test is performed over a temperature range from room temperature (25-30° C.) to 160° C. with a heating rate of 2° C./min. The frequency is set at 0.1 Hz. Data evaluation is done with a plot of dynamic strain versus temperature and the softening point is indicated by the dynamic strain inflection point. The test can be conducted on a Perkin Elmer DMA 8000 dynamic mechanical analyzer.

### Differential Scanning Calorimetry (DSC Test)

Using differential scanning calorimetry (DSC), the melting point of the sample can be determined by ISO Test No. 11357 under the following conditions: The sample is heated from 0° C. to 180° C. with a heating rate of 10° C./min and held isothermally for 5 min at 180° C. After the isothermal hold, the sample is cooled to 0° C. with a heating rate of 10° C./min. Finally, the sample is heated to 180° C. with a heating rate of 20° C. The sample is inerted with nitrogen during all steps of the DSC procedure. The test can be conducted using a DSC Q2000 calorimeter available from TA Instruments.

Contact angle measurements are performed on a Krüss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition well suited for producing gel extruded articles, such as fibers and films, including porous membranes. The polymer composition contains at least one high density polyethylene polymer in combination with an olefinic copolymer. The olefinic copolymer, for instance, can comprise an ethylene vinyl acetate copolymer having a controlled amount of vinyl acetate units. Controlling the amount of vinyl acetate within the ethylene vinyl acetate copolymer has been found to dramatically improve many properties of the polymer composition, especially when extruded into various articles, such as fibers and films, such as porous membranes.

For example, adding an olefinic copolymer to the high density polyethylene polymer produces membranes with increased adhesive properties. When the porous membrane is incorporated into an electrochemical cell, such as a lithium ion battery, for instance, the porous membrane of the present disclosure adheres better to an adjacent anode and to an adjacent cathode. Improving adhesion between the porous membrane and the cathode or anode can not only facilitate the process of producing the electrochemical cell but can also improve the properties of the cell. Improving adhesion between the anode and the cathode, for instance, can lead to greater conductivity and ion flow through the membrane.

Combining an olefinic copolymer with one or more high density polyethylene polymers can also produce porous membranes having a lower shutdown temperature. Of particular advantage, the shutdown temperature can be decreased without compromising other physical properties. Even small decreases in the shutdown temperature, for instance, can offer dramatic improvements in safety and other functions of the porous membrane, especially when incorporated into an electrochemical cell, such as a lithium ion battery.

Addition of the olefinic copolymer to one or more high density polyethylene polymers can also produce polymer articles, such as porous membranes, having improved wettability characteristics, especially when tested against electrolytes. The porous membranes, for instance, can also display dramatically enhanced wicking properties. When incorporated into a battery, for instance, improved wettability helps reduce the battery membrane soaking time, which leads to higher productivity. In addition, the increased wettability with the electrolyte solution increases the mobility of the ions, such as the lithium ions, which can significantly increase battery lifetime. Further, membranes made according to the present disclosure can have improved wicking properties when contacted with an electrolyte solution.

As described above, the polymer composition of the present disclosure and articles made from the composition generally contain one or more high density polyethylene polymers. In one aspect, the polymer composition contains a blend of high density polyethylene polymers. The one or more high density polyethylene polymers can form the primary polymer component and the matrix polymer of the polymer composition. The high density polyethylene polymers can have a density of about 0.93 g/cm³ or greater, such as about 0.94 g/cm³ or greater, such as about 0.95 g/cm³ or greater, and generally less than about 1 g/cm³, such as less than about 0.96 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium (IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium (IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium (IV) compound with a trialkyl aluminum compound in an inert organic solvent at temperatures in the range of −40° C. to 200° C., preferably −20° C. to 150° C. In the first step the titanium (IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium (IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

In one embodiment, the polyethylene particles are made from a polyethylene polymer having a relatively low bulk density as measured according to DIN53466. For instance, in one embodiment, the bulk density is generally less than about 0.6 g/cm³, such as less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than about 500 microns, such as less than about 400 microns, such as less than about 300 microns, such as less than about 200 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high density polyethylene polymer can be less than about 4,000,000 g/mol, such as less than about 3,000,000 g/mol.

The polyethylene may have a viscosity number of from at least 100 mL/g, such as at least 500 mL/g, such as at least 550 mL/g, to less than about 6,000 mL/g, such as less than about 5,000 mL/g, such as less than about 4,000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%. Crystallinity can be measured using differential scanning calorimetry (DSC).

In general, the high density polyethylene particles as described above are present in the polymer composition in from 0% and up to about 50% by weight, when combined with a plasticizer prior to forming articles. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

In accordance with the present disclosure, one or more high density polyethylene polymers are combined with an olefinic copolymer in order to improve at least one property of the polymer composition and/or one property of a polymer article made from the polymer composition. In one aspect, the olefinic copolymer can be an ethylene vinyl acetate copolymer which is generally derived from at least one ethylene monomer and at least one vinyl acetate monomer. Certain aspects of the copolymer can be selectively controlled to help achieve the desired properties. For instance, the vinyl acetate content of the copolymer may be selectively controlled to be relatively low. For example, commercially available ethylene vinyl acetate copolymers can contain vinyl acetate in an amount up to about 60% by weight. It was discovered, however, that ethylene vinyl acetate copolymers having a relatively low vinyl acetate monomer content have better compatibility with one or more high density polyethylene polymers when extruded together. Lower amounts of vinyl acetate monomer, for instance, lead to the production of polymer articles having better mechanical properties with less phase separation.

In one aspect, for instance, the ethylene vinyl acetate copolymer can have a vinyl acetate monomer content of less than about 30% by weight, such as less than about 29% by weight, such as less than about 25% by weight, such as less than about 20% by weight, such as less than about 15% by weight, such as less than about 14% by weight, such as less than about 13% by weight, and generally greater than about 3% by weight, such as greater than about 5% by weight, such as greater than about 6% by weight, such as greater than about 7% by weight such as greater than about 8% by weight, such as greater than about 9% by weight, such as greater than about 10% by weight, such as greater than about 11% by weight.

The melt flow rate or melt flow index of the ethylene vinyl acetate copolymer is also relatively low. For instance, the melt flow index of the ethylene vinyl acetate copolymer can be less than about 20 g/10 min, such as less than about 10 g/10 min, such as less than about 8 g/10 min, such as less than about 5 g/10 min, such as less than about 4 g/10 min, such as less than about 3 g/10 min, and generally greater than about 0.1 g/10 min, such as greater than about 0.8 g/10 min, such as greater than about 1.2 g/10 min. Melt flow index can be measured according to ASTM Test D1238-20 at a temperature of 190° C. and at a load of 2.16 kilograms for the ethylene vinyl acetate copolymer component.

The density of the ethylene vinyl acetate copolymer(s) may range from about 0.900 to about 1.00 gram per cubic centimeter (g/cm³), in some embodiments from about 0.910 to about 0.980 g/cm³, and in some embodiments, from about 0.920 to about 0.975 g/cm³, as determined in accordance with ASTM D1505-18. The melting temperature of the ethylene vinyl acetate copolymer may be from about 70° C. to about 115° C., in some embodiments from about 80° C. to about 110° C., and in some embodiments, from about 95° C. to about 105° C., such as determined in accordance with ASTM D3418-15.

Any of a variety of techniques may generally be used to form the ethylene vinyl acetate copolymer(s) with the desired properties. In one embodiment, the polymer is produced by copolymerizing an ethylene monomer and a vinyl acetate monomer in a high pressure reaction. Vinyl acetate may be produced from the oxidation of butane to yield acetic anhydride and acetaldehyde, which can react together to form ethylidene diacetate. Ethylidene diacetate can then be thermally decomposed in the presence of an acid catalyst to form the vinyl acetate monomer. Examples of suitable acid catalysts include aromatic sulfonic acids (e.g., benzene sulfonic acid, toluene sulfonic acid, ethylbenzene sulfonic acid, xylene sulfonic acid, and naphthalene sulfonic acid), sulfuric acid, and alkanesulfonic acids, such as described in U.S. Pat. No. 2,425,389 to Oxley et al.; U.S. Pat. No. 2,859,241 to Schnizer; and U.S. Pat. No. 4,843,170 to Isshiki et al. The vinyl acetate monomer can also be produced by reacting acetic anhydride with hydrogen in the presence of a catalyst instead of acetaldehyde. This process converts vinyl acetate directly from acetic anhydride and hydrogen without the need to produce ethylidene diacetate. In yet another embodiment, the vinyl acetate monomer can be produced from the reaction of acetaldehyde and a ketene in the presence of a suitable solid catalyst, such as a perfluorosulfonic acid resin or zeolite.

In addition to controlling monomer content, in one aspect, the particle size of the olefinic copolymer, such as the particle size of the ethylene vinyl acetate copolymer, can be controlled when blended with one or more high density polyethylene polymers. For instance, the median particle size of the ethylene vinyl acetate copolymer can be within about 60%, such as within about 50%, such as within about 40%, such as within about 30%, such as within about 20%, such as within about 10% of the median particle size of the high density polyethylene polymer particles.

In another aspect, the particle size of the olefinic copolymer, such as the particle size of the ethylene vinyl acetate copolymer, can be much larger than the particle size of the one or more high density polyethylene polymers. For instance, in one aspect, the high density polyethylene particles can be combined with an ethylene vinyl acetate copolymer in the form of pellets.

In one aspect, the ethylene vinyl acetate copolymer particles can have a median particle size of greater than about 0.5 mm, such as greater than about 1 mm, such as greater than about 2 mm, and less than about 5 mm, such as less than about 4.5 mm. In another aspect, the ethylene vinyl acetate copolymer particles can be produced and/or ground so as to have a median particle size of less than about 1000 microns, such as less than about 700 microns, such as less than about 500 microns, such as less than about 300 microns, such as less than about 200 microns, such as less than about 150 microns. The median particle size of the ethylene vinyl acetate copolymer particles can be greater than about 50 microns, such as greater than about 75 microns, such as greater than about 100 microns, such as greater than about 200 microns, such as greater than about 300 microns, such as greater than about 400 microns, such as greater than about 500 microns, such as greater than about 600 microns.

The amount of olefinic copolymer or ethylene vinyl acetate copolymer incorporated into the polymer articles made according to the present disclosure can vary depending upon the particular application and the desired result. In general, polymer articles made according to the present disclosure can contain one or more ethylene vinyl acetate copolymers in an amount of from about 0.1% by weight to about 30% by weight, including all increments of 0.1% by weight therebetween. For example, the polymer articles can contain one or more ethylene vinyl acetate copolymers in an amount greater than about 0.3% by weight, such as in an amount greater than about 0.8% by weight, such as in an amount greater than about 1% by weight, such as in an amount greater than about 1.5% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight, such as in an amount greater than about 5% by weight. One or more ethylene vinyl acetate copolymers can be present in the polymer articles in an amount less than about 25% by weight, such as in an amount less than about 20% by weight, such as in an amount less than about 18% by weight, such as in an amount less than about 15% by weight, such as in an amount less than about 12% by weight, such as in an amount less than about 10% by weight, such as in an amount less than about 8% by weight, such as in an amount less than about 6% by weight. In various embodiments, one or more vinyl acetate copolymers can be present in the polymer articles in an amount from about 1% by weight to about 12% by weight, such as in an amount from about 1.5% by weight to about 4.5% by weight.

In addition to one or more olefinic copolymers, the polymer composition of the present disclosure can also contain a compatibilizing agent that serves to compatibilize the blending of the one or more ethylene vinyl acetate copolymers with one or more high density polyethylene polymers. The compatibilizing agent, for instance, can comprise a polyethylene polymer that has been grafted to a compatibilizer. The compatibilizer, for instance, may comprise maleic anhydride groups, acrylic acid groups, or the like. The polyethylene grafted to the compatibilizer can be a high density polyethylene polymer. The compatibilizer can be present in the grafted polymer in an amount greater than about 0.3% by weight, such as in an amount greater than about 1% by weight, such as in an amount greater than about 1.5% by weight, such as in an amount greater than about 2% by weight, such as in an amount greater than about 3% by weight, and generally in an amount less than about 25% by weight, such as in an amount less than about 20% by weight, such as in an amount less than about 15% by weight, such as in an amount less than about 10% by weight. The compatibilizing agent can be present in the polymer article formed from the polymer composition in an amount of greater than about 0.5% by weight, such as in an amount greater than about 1% by weight, such as in an amount greater than about 1.5% by weight, such as in an amount greater than about 2% by weight, such as in an amount greater than about 2.5% by weight, and generally in an amount less than about 25% by weight, such as in an amount less than about 15% by weight, such as in an amount less than about 10% by weight, such as in an amount less than about 7% by weight, such as in an amount less than about 5% by weight.

In order to form molded articles in accordance with the present disclosure, the polymer composition containing one or more high density polyethylene polymers, one or more olefinic copolymers, and optionally one or more compatibilizing agents is combined with a plasticizer according to a process known as gel processing. During gel processing, one or more plasticizers is combined with the polymer composition which can then be later removed in forming polymer articles.

For example, in one embodiment, the resulting polymer article can contain one or more high density polyethylene polymers in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 95% by weight, such as in an amount greater than about 97% by weight, and generally in an amount less than about 98% by weight.

In general, any suitable plasticizer can be combined with the other components as long as the plasticizer is capable of forming a gel-like material suitable for gel spinning or extruding. The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

In order to form polymer articles in accordance with the present disclosure, the high density polyethylene particles and olefinic copolymer particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polymer mixture to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

In one embodiment, porous membranes made in accordance with the present disclosure can optionally be subjected to a plasma treatment, such as an oxygen plasma treatment. The plasma treatment can further improve the compatibility of the porous polymer membrane with the electrolyte solution and increase ion conductivity.

For example, in one aspect, the plasma process of the present disclosure is conducted using microwave discharge. In addition, the process can be carried out at very low pressures and at extremely short contact times so as to preserve the physical properties of the porous polymer film.

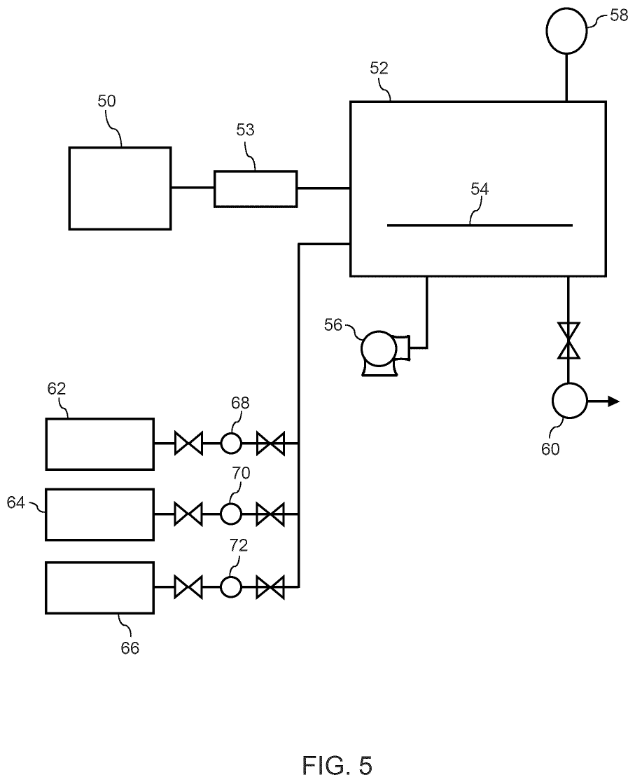

One embodiment of a plasma process that may be used in accordance with the present disclosure is shown in FIG. 5. Referring to FIG. 5, the plasma process includes a microwave supply 50 that is in communication with a vacuum chamber 52 via a resonant cavity 53. The resonant cavity 53 can include or be associated with an impedance matching system. A substrate holder 54 is contained within the vacuum chamber 52. The vacuum chamber 52 is also associated with a pressure monitoring device 58.

In order to evacuate the chamber 52, the chamber 52 can be placed in communication with a pump 56. The vacuum chamber 52 is also in communication with an exhaust 60.

As shown in FIG. 5, the vacuum chamber 52 can also be placed in fluid communication with one or more gas supplies. In the embodiment illustrated in FIG. 5, three different gas supplies are shown 62, 64, and 66. Each gas supply 62, 64, and 66 is placed in association with a corresponding mass flow rate controller 68, 70, and 72. The gas supplies 62, 64, and 66 are for feeding oxygen alone or in combination with other gases to the vacuum chamber 52.

As described above, in one embodiment, a microwave plasma reactor is used to deliver an oxygen plasma to the porous polymer films. Although other plasma reactors may be used in accordance with the present disclosure, in one embodiment, a low pressure plasma system with microwave discharge is preferred. Alternatively, an inductively coupled plasma system may be used that contains an RF generator.

During oxygen plasma treatment, a porous polymer film sample is placed into the vacuum chamber 52 and the chamber is evacuated using the pump 56. A plasma is then fed to the vacuum chamber 52 produced by the microwave supply 50 in conjunction with one or more gases that contain oxygen. Sources of oxygen can vary depending upon the particular application. In one embodiment, pure oxygen gas is fed to the vacuum chamber 52. In alternative embodiments, however, oxygen can be combined with other gases, such as inert gases. For instance, oxygen can be combined with nitrogen. In one embodiment, air is fed to the plasma chamber 52. Other sources of oxygen include hydrogen peroxide, water (steam), nitrous oxide, ozone, and the like. In one embodiment, the gas that is fed to the plasma chamber 52 contains greater than about 20% oxygen, such as greater than about 30% oxygen, such as greater than about 50% oxygen by volume.

During oxygen plasma treatment, an ionized gas is formed that contains various different positive and negative ions and optionally free radicals, photons, and neutral species. The ionized gas initiates reactions on the surface of the porous polymer film that ultimately modify the chemical properties of the surface. For instance, the polyethylene polymer can be oxidized in the presence of oxygen. The plasma oxidized surface, for instance, can contain various different polar groups that increase the polarity of the surface of the porous polymer film.

The conditions within the plasma chamber 52 during the plasma process can vary. In one embodiment, the oxygen plasma process is carried out at low pressures. For instance, the pressure within the chamber can be maintained below one atmosphere. For instance, the pressure within the chamber can be below about 10,000 pa, such as less than about 5,000 pa, such as less than about 1,000 pa, such as less than about 500 pa, such as less than about 300 pa, such as less than about 200 pa. In one embodiment, the process is carried out at very low pressures such as less than about 150 pa, such as less than about 130 pa, such as less than about 100 pa, such as less than about 80 pa, such as less than about 50 pa, such as less than about 30 pa. The temperature during the process can generally be less than about 110° C., such as less than about 100° C., such as less than about 80° C., such as less than about 60° C., such as less than about 50° C., such as less than about 40° C., such as less than about 30° C., such as less than about 28° C., such as less than about 25° C., and generally greater than about 15° C., such as greater than about 20° C.

In accordance with the present disclosure, the contact time between the porous polymer film and the oxygen plasma, in one embodiment, can be relatively short. For example, in one embodiment, each side of the porous polymer film can be exposed to the plasma for times of less than about 30 seconds, such as less than about 25 seconds, such as less than about 20 seconds, such as less than about 15 seconds, such as less than about 12 seconds, such as less than about 10 seconds, such as less than about 8 seconds, such as less than about 6 seconds. Contact times are generally greater than about 1 second, such as greater than about 2 seconds, such as greater than about 3 seconds. It was discovered that very short contact times provide the necessary ion conductivity without adversely impacting the physical properties of the film, especially when using microwave generated plasma at low pressures.

Polymer articles made in accordance with the present disclosure have numerous uses and applications. For example, in one embodiment, the process is used to produce a porous membrane. The membrane can be used, for instance, as a battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

Referring to FIG. 1, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer polymer membrane and does not include a multilayer or coextruded structure. In one aspect, the single layer polymer membrane may also include a coating. The coating can be an inorganic coating made from, for instance, aluminum oxide or a titanium oxide. Alternatively, the single layer polymer membrane may also include a polymeric coating.

Porous membranes made according to the present disclosure can generally have a thickness of greater than about 4 microns, such as greater than about 5 microns, such as greater than about 6 microns, such as greater than about 7 microns, such as greater than about 8 microns, such as greater than about 9 microns, such as greater than about 10 microns, such as greater than about 11 microns. The thickness of the membranes is generally less than about 25 microns, such as less than about 20 microns, such as less than about 16 microns, such as less than about 14 microns, such as less than about 12 microns, such as less than about 10 microns.

Membranes made according to the present disclosure can have excellent physical properties. For example, membranes having a porosity of from about 20% to about 60%, such as from about 25% to about 50%, can have a puncture strength of greater than about 800 mN/micron, such as greater than about 980 mN/micron, such as greater than about 1,060 mN/micron, such as greater than about 1,100 mN/micron, such as greater than about 1,200 mN/micron, and generally less than about 3,000 mN/micron.

Membranes made according to the present disclosure can also have excellent tensile strength properties in either the machine direction or the cross-machine direction. For instance, in either direction, the membrane can have a tensile strength of greater than about 115 MPa, such as greater than about 120 MPA, such as greater than about 125 MPa, and generally less than about 250 MPa.

Polymer membranes made according to the present disclosure can have a Gurley permeability of greater than about 50 sec/100 mL, such as greater than about 70 sec/100 ml, such as greater than about 80 sec/100 ml, such as greater than about 90 sec/100 ml, such as greater than about 105 sec/100 ml, such as greater than about 150 sec/100 ml, such as greater than about 200 sec/100 ml, such as greater than about 225 sec/100 ml, such as greater than about 250 sec/100 ml, such as greater than about 275 sec/100 ml, such as greater than about 300 sec/100 ml, such as greater than about 325 sec/100 ml, such as greater than about 350 sec/100 ml, such as greater than about 375 sec/100 ml, such as greater than about 400 sec/100 ml, such as greater than about 425 sec/100 ml, such as greater than about 450 sec/100 ml, such as greater than about 475 sec/100 ml, such as greater than about 500 sec/100 ml, such as greater than about 525 sec/100 ml, such as greater than about 550 sec/100 ml, such as greater than about 575 sec/100 ml, such as greater than about 600 sec/100 ml, and generally less than about 1,000 sec/100 ml.

Porous membranes made according to the present disclosure can generally have a porosity of greater than about 25%, such as greater than about 30%, such as greater than about 35%, and generally less than about 60%, such as less than about 55%, such as less than about 50%, such as less than about 45%. In one aspect, the porosity can be from about 35% to about 40%. In an alternative embodiment, the porosity can be from about 39% to about 50%. The mean pore size can generally be greater than about 20 nm, such as greater than about 23 nm, such as greater than about 25 nm, such as greater than about 26 nm, and generally less than about 70 nm, such as less than about 60 nm, such as less than about 50 nm, such as less than about 45 nm, such as less than about 40 nm, such as less than about 35 nm.

The polymer composition can also dramatically enhance the ability of molded articles, such as porous membranes, to wick fluids, particularly electrolyte fluids. For example, when subjected to a soaking test in propylene carbonate, the presence of the olefinic copolymer can increase the soaking distance and/or the soaking speed by greater than about 5%, such as by greater than about 10%, such as by greater than about 20%, such as by greater than about 30%, such as by greater than about 35% after 10 hours in comparison to a similar membrane not containing the olefinic copolymer. The soaking distance of membranes can vary depending on many factors such as the porosity of the membrane and the pore size.

In one aspect, for instance, the soaking distance of membranes made according to the present disclosure can be based upon the permeability of the porous membrane in conjunction with the thickness of the membrane. For instance, the soaking distance of membranes made according to the present disclosure can have the following relationship when tested in propylene carbonate:

Soaking distance(mm)≥−0.1473(x)+13.935

wherein x is the Gurley permeability (sec/100 mL)/thickness (microns). In other embodiments, the soaking distance can be greater than or equal to the following:

Soaking distance (mm)≥−0.1473(x)+15.00

Soaking distance (mm)≥−0.1473(x)+16.00

Porous membranes made according to the present disclosure can display a soaking speed in propylene carbonate of greater than about 0.55 mm/hr, such as greater than about 0.6 mm/hr, such as greater than about 0.7 mm/hr, such as greater than about 0.75 mm/hr, and less than about 5 mm/hr.

Porous membranes made in accordance with the present disclosure can also have a decreased shutdown temperature. For example, the olefinic copolymer can be present in the membrane in an amount sufficient to decrease the shutdown temperature by greater than about 0.5° C., such as greater than about 0.8° C., such as greater than about 1° C., such as greater than about 1.2° C., such as greater than about 1.6° C., such as greater than about 1.8° C., such as greater than about 2° C., such as greater than about 2.4° C., such as greater than about 2.8° C., such as greater than about 3.2° C., such as greater than about 3.6° C. The shutdown temperature of the membrane, for instance, can be less than about 140° C., such as less than about 138° C., such as less than about 136° C., such as less than about 135° C., such as less than about 134° C., such as less than about 133° C., such as less than about 132° C., such as less than about 131° C., such as less than about 130° C. The shutdown temperature is generally greater than about 120° C., such as greater than about 125° C.

In addition to the above properties and characteristics, polymer articles, particularly porous membranes, made in accordance with the present disclosure also have enhanced wettability properties when tested against water depending on the surface roughness. For example, the olefinic copolymer of the present disclosure can be incorporated into a polymer article in an amount sufficient to optionally reduce a contact angle of the article when measured against water in an amount greater than about 4%, such as in an amount greater than about 5%, such as in an amount greater than about 6%, such as in an amount greater than about 7%. Polymer articles, such as porous membranes, made in accordance with the present disclosure, for instance, may display a contact angle against water of less than about 105°, such as less than about 102°, such as less than about 100°, such as less than about 98°, and generally greater than about 50°.

Of particular advantage, in one aspect, the olefin copolymer can be incorporated into polymer articles, especially films such as porous membranes, that have improved adhesive properties to other structures. For instance, adding the olefin copolymer into the polymer article can produce porous membranes that have greater adhesive characteristics when placed against anodes and cathodes. The greater adhesive force between the components can improve not only the structure of the electrolytic cell but can also translate into improved ion conductivity and performance.

Porous membranes made according to the present disclosure can be characterized by an IR spectrum having peaks at 1740, 1240, and 1020 cm⁻¹±20 cm⁻¹, such as ±5 cm⁻¹, such as ±1 cm⁻¹.

The polymer composition and polymer articles made in accordance with the present disclosure may contain various other additives, such as heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate, or a salt of another organic acid, such as a citrate. Other acid scavengers include carbonates, oxides, or hydroxides. Particular acid scavengers that may be incorporated into the polymer composition include a metal stearate, such as calcium stearate. Still other acid scavengers include tricalcium citrate, zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following examples. The following examples are given below by way of illustration and not by way of limitation. The following experiments were conducted in order to show some of the benefits and advantages of the present invention.

### Example No. 1

Various resin compositions were formulated containing a base resin of high density polyethylene. The high density polyethylene polymer was combined with an ethylene vinyl acetate copolymer containing 12% by weight vinyl acetate. The high density polyethylene polymer had a molecular weight of 700,000 g/mol and an average particle size (d50) of about 115 microns. The polyethylene polymer had a melt flow rate of 0.5 g/10 min. The two polymers were blended together using a tumble blender. The following samples were produced:

| Sample | Amount of high density | Amount of ethylene vinyl |
|---|---|---|
| No. | polyethylene polymer base resin | acetate copolymer |
| 1 | 100% | 0 |
| 2 | 98.5% | 1.5% |
| 3 | 95% | 5% |

The resin compositions were prepared into membranes via gel extrusion, biaxial stretching, and solvent extraction as are conventional.

The blends were gel extruded using a solid content of 30 wt. % resin and paraffin oil at a temperature of from about 190° C. to about 240° C. and a screw speed of 200 rpm. After extrusion, the resulting membrane was solidified on a chill roller set to 40° C. Stretching was performed at an approximate ratio of 7×7 (MD/TD) at a temperature of 120° C. Extraction of the stretched membranes was performed in acetone. The membranes were annealed at 120° C. for 10 minutes.

The membranes were then tested according to the soaking test with propylene carbonate and the following results were obtained.

| Sample No. | Soaking test increase from Sample No. 1 |
|---|---|
| 1 | — |
| 2 | 20% |
| 3 | 50% |

As shown above, samples made containing the ethylene vinyl acetate copolymer displayed a dramatically increased soaking or wicking distance.

### Example No. 2

An ethylene vinyl acetate copolymer was combined with a high density polyethylene polymer as described in Example No. 1 to produce porous membranes. In this example, the ethylene vinyl acetate copolymer was contained in the polymer composition in an amount of 3.5% by weight. The remainder of the composition comprised the high density polyethylene polymer having a molecular weight of 700,000 g/mol.

For comparative purposes, various porous membranes were formed only containing the high density polyethylene polymer.

Each of the porous membranes were subjected to the soaking test with propylene carbonate. As described above, it was discovered that the soaking distance is dependent upon the Gurley permeability of the porous membrane and the thickness of the membrane. The porous membranes made from the combination of the high density polyethylene polymer and the ethylene vinyl acetate copolymer are identified as Sample No. 4, while the membranes made only from the high density polyethylene polymer are identified as Sample No. 5. For the membranes produced, the soaking distance was measured in relation to the Gurley permeability in sec/100 mL divided by the thickness of the membrane in microns. The following results were obtained:

Sample No. 4

| Gurley (sec/100 mL)/thickness | |
|---|---|
| (microns) | Soaking distance (mm) |
| 31.75 | 11.67 |
| 26.95 | 12.14 |
| 24.92 | 12.38 |
| 35.53 | 9.76 |
| 25.31 | 11.67 |
| 33.49 | 10.48 |
| 26.12 | 12.62 |
| 23.48 | 13.81 |
| 52.05 | 8.57 |
| 55.91 | 7.86 |
| 56.50 | 6.67 |
| 65.20 | 6.67 |
| 54.01 | 9.29 |
| 59.36 | 7.38 |
| 70.09 | 7.62 |

Sample No. 5

| Gurley (sec/100 mL)/thickness | |
|---|---|
| (microns) | Soaking distance (mm) |
| 23.59 | 10.00 |
| 35.31 | 7.38 |
| 40.41 | 4.52 |
| 26.89 | 8.10 |
| 49.02 | 3.57 |
| 27.97 | 8.33 |
| 35.67 | 6.19 |
| 56.24 | 3.57 |
| 63.58 | 3.10 |
| 35.99 | 7.86 |
| 82.37 | 0.95 |
| 72.09 | 3.10 |
| 63.93 | 1.19 |
| 25.42 | 9.05 |
| 22.07 | 8.57 |
| 23.32 | 9.29 |
| 22.96 | 8.81 |

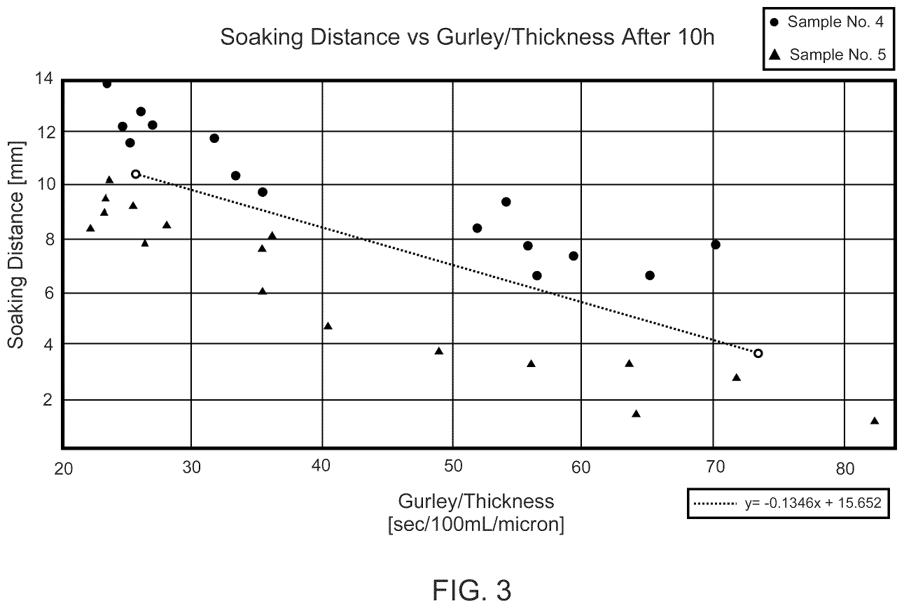

The results above are graphically illustrated in FIG. 3. As shown, porous membranes made according to the present disclosure displayed a dramatically improved soaking distance in relation to the reference samples. As shown, all of the samples made in accordance with the present disclosure had a soaking distance in millimeters that was greater than the following relationship:

$$Soaking distance ( mm ) \geq - 0.1473 ( x ) + 13.935$$

where x is the Gurley permeability (sec/100 mL)/thickness (microns).

The membranes were also tested for soaking speed in mm distance per hour. Sample No. 5 made from the reference data exhibited a soaking speed of 0.5 mm/hr. The Sample No. 4 membranes made according to the present disclosure, however, displayed a soaking speed of 0.8 mm/hr. Consequently, not only do membranes made according to the present disclosure display a much greater soaking distance but also do so at a rapid rate.

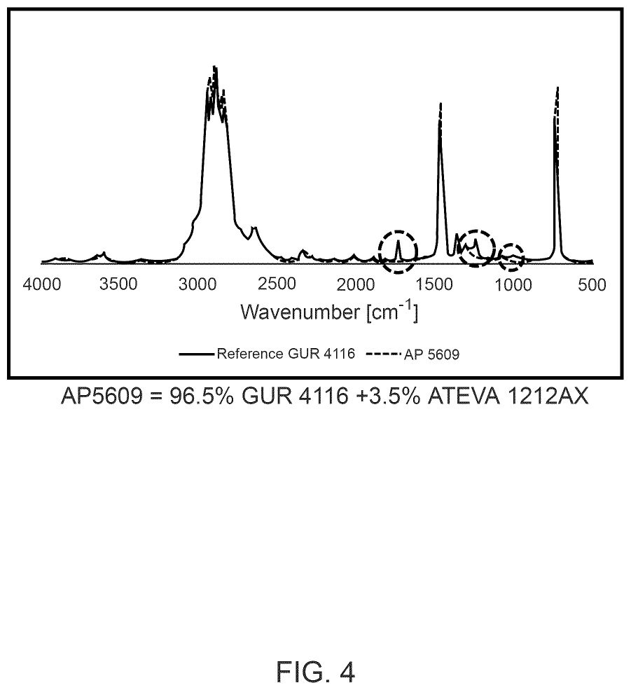

The polymer composition used to produce the membranes of Sample No. 4 was also subjected to IR spectroscopy. The results are illustrated in FIG. 4. As shown, the presence of the ethylene vinyl acetate copolymer caused peaks to form at 1740 cm⁻¹, at a 1240 cm⁻¹ and at a 1020 cm⁻¹.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. An ion separator for dividing an anode from a cathode comprising:
a porous polymer film, the porous polymer film comprising a high density polyethylene polymer blended with an olefinic copolymer, the polyethylene polymer having a number average molecular weight of greater than about 300,000 g/mol, the olefinic copolymer comprising an ethylene vinyl acetate copolymer, the ethylene vinyl acetate copolymer having a vinyl acetate monomer content of less than about 30% by weight.

2. An ion separator as defined in claim 1, wherein the ethylene vinyl acetate copolymer has a vinyl acetate monomer content of from about 5% by weight to about 29% by weight.

3. An ion separator as defined in claim 1, wherein the ethylene vinyl acetate copolymer has a melt flow index of from about 0.1 g/10 min. to about 20 g/10 min. as determined in accordance with ASTM D1238-20 at a temperature of 190° C. and a load of 2.16 kilograms.

4. An ion separator as defined in claim 1, wherein the ethylene vinyl acetate copolymer is present in the porous polymer film in an amount of from about 0.1% by weight to about 30% by weight.

5. An ion separator as defined in claim 1, wherein the polymer film has a shutdown temperature of from about 120° C. to less than 140° C.

6. An ion separator as defined in claim 1, wherein the olefinic copolymer is present in the porous film in an amount sufficient to increase the soaking distance (mm) and/or the soaking speed (mm/h) in propylene carbonate by greater than about 5% after 10 hours in comparison to a similar membrane not containing the olefinic copolymer.

7. An ion separator as defined in claim 1, wherein the porous polymer film has a thickness of from about 4 microns to about 25 microns and has a porosity of from about 20% to about 60%.

8. An ion separator as defined in claim 1, wherein the high density polyethylene polymer is present in the porous film in an amount of from about 60% by weight to about 99% by weight.

9. An ion separator as defined in claim 1, wherein the high density polyethylene has a molecular weight of greater than about 400,000 g/mol and less than about 12,000,000 g/mol.

10. An ion separator as defined in claim 1, wherein the ion separator is a single layer polymer porous film that may optionally include a coating.

11. An ion separator as defined in claim 1, wherein the porous film has a soaking distance in propylene carbonate according to the following relationship:
Soaking distance (mm)≥−0.1473(x)+13.935
wherein x is the Gurley permeability (sec/100 mL)/thickness (microns) and wherein the porous film displays a soaking speed in propylene carbonate of greater than about 5.5 mm/h.

12. A polymer composition for producing gel extruded articles comprising:
a plasticizer;
high density polyethylene particles comprising at least one high density polyethylene polymer, the high density polyethylene polymer having a number average molecular weight of greater than about 300,000 g/mol, the high density polyethylene particles having a median particle size by volume of from about 70 microns to about 500 microns; and
olefinic copolymer particles, the olefinic copolymer comprising an ethylene vinyl acetate copolymer, the olefinic copolymer particles having a median particle size by volume of from about 70 microns to about 5 mm.

13. A polymer composition as defined in claim 12, wherein the ethylene vinyl acetate copolymer has a vinyl acetate monomer content of from about 5% by weight to about 30% by weight.

14. A polymer composition as defined in claim 12, wherein the ethylene vinyl acetate copolymer has a melt flow index of from about 0.1 g/10 min. to about 20 g/10 min as determined in accordance with ASTM D1238-20 at a temperature of 190° C. and a load of 2.16 kilograms.

15. A polymer composition as defined in claim 12, wherein the ethylene vinyl acetate copolymer is present in an amount of from about 0.1% by weight to about 30% by weight based on the total weight of the ethylene vinyl acetate copolymer and the high density polyethylene polymer.

16. A polymer composition as defined in claim 12, wherein the high density polyethylene polymer is present in the polymer composition in an amount of from about 60% by weight to about 99% by weight based on the total weight of the ethylene vinyl acetate copolymer and the high density polyethylene polymer and wherein the high density polyethylene has a molecular weight of greater than about 400,000 g/mol and less than about 12,000,000 g/mol.

17. A polymer composition as defined in claim 12, wherein the high density polyethylene particles have a median particle size by volume of from about 70 microns to about 210 microns and the olefinic copolymer particles having a median particle size by volume of from about 70 microns to about 5 mm.

18. A process for producing polymer articles comprising:
forming the polymer composition as defined in claim 12;
extruding the gel-like composition through a die to form a polymer article, the polymer article comprising a film; and
removing at least part of the plasticizer from the polymer article.

19. An ion separator for dividing an anode from a cathode comprising a porous polymer film, the porous polymer film comprising at least one high density polyethylene polymer, the porous polymer film being characterized by an IR spectrum having peaks at 1740, 1240, and 1020 cm−1±20 cm⁻¹.

20. An ion separator for dividing an anode from a cathode comprising a porous polymer film, the porous polymer film comprising at least one high density polyethylene polymer blended with an ethylene vinyl acetate copolymer, the ethylene vinyl actate compolymer being present in the porous polymer film in an amount sufficient toincrease the soaking distance (mm) and/or the soaking speed (mm/h) in propylene carbonate by greater than about 5% after 10 hours in comparison to a similar membrane not containing the ethylene vinyl acetate copolymer.
